(19) United States
(12) Patent Application Publication
(10) Pub. No.: US 2004/0028792 A1
(43) Pub. Date: Feb. 12, 2004

(54) Method for producing water rich in calcium and water obtained

(76) Inventors: Henri Jauffret, Antony (FR); Christophe Lascoste, Cebazat (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/297,574

(22) PCT Filed: Jun. 21, 2001
(86) PCT No.: PCT/FR01/01955

(51) Int. Cl. C12C 1/00

(52) U.S. Cl. 426/590

(57) ABSTRACT

The invention concerns a method for producing drinking water comprising the following steps: a) dissolving carbon dioxide in weakly mineralised drinking water; b) circulating the carbonated water derived from step a) in a chamber wherein is confined calcium carbonate in solid form; and c) adding, to the water derived from step b), a solution comprising calcium sulphate and/or calcium chloride. The invention also concerns water rich in calcium obtained by said method.

The present invention relates to a method for producing water rich in calcium and the water obtained by this method.

Calcium is the most abundant inorganic element in the human body, present at 99% in the bones. This element plays a role in bone construction, muscle contraction, the transmission of nerve signals and ion exchanges across the cell membranes. It is also involved in the secretion of hormones, of digestive enzymes and of neurotransmitters.

The recommended daily intake (RDI) of calcium is 800 mg for men and women over 24 years, a higher calcium intake being required during pregnancy and breastfeeding for example.

Milk, dairy products and some vegetables (in particular broccoli, kale and parsley) are foods which are naturally rich in calcium. Water may also constitute an important source of calcium. Indeed, unlike spring water which is usually low in calcium, some types of mineral water are naturally rich in this mineral.

However in these types of plain water, calcium is mainly present in sulfate form (CaSO₄), a form which is poorly assimilated in the intestine and which confers on the water a taste which is commonly described as unpleasant by consumers.

Calcium chloride (CaCl₂) is sometimes added in order to enrich bottled water with calcium. Although this salt is very soluble in water, it does not make it possible to obtain a very high calcium concentration since the quantity of calcium chloride in drinking water is limited to 250 mg/l by European directives. In addition, as with calcium sulfate, calcium chloride confers a poor taste on the water.

The aim of the present invention is therefore to provide drinking water which is particularly rich in calcium and which does not have the disadvantages of previously known water rich in calcium, and a method for producing such water.

The subject of the invention is a method for producing drinking water characterized in that it comprises the following steps:

a) dissolving carbon dioxide in weakly mineralized drinking water,

b) circulating the carbonated water derived from a) in a chamber wherein is confined calcium carbonate in solid form, and

c) adding, to the water derived from step b), a solution comprising calcium sulfate and/or calcium chloride.

The expression “drinking water” is understood to mean drinking water suitable for daily human consumption, water which does not exist as such in nature but whose mineral element composition is adjusted by an industrial method.

Moreover, the expression “carbonated water” is understood to mean water comprising carbon dioxide and “weakly mineralized drinking water” is understood to mean drinking water which does not contain calcium ions or which contains less than 50 mg/l thereof. It is clearly understood that it is also possible to use water which comprises less than 150 mg/l of calcium ions, or, in general, any water which does not contain the desired level of calcium ions.

In an advantageous embodiment of the method in accordance with the invention, carbon dioxide is dissolved in the weakly mineralized water, during step a) of the method, at a rate of between 4 and 10 kg/h, so that the water comprises, at the end of step a), between 200 and 500 mg/l of carbon dioxide, preferably about 350 mg/l. The rate of dissolution of carbon dioxide mentioned above (as well as all the rates which will be indicated in the text which follows) is expressed for a water flow rate, during the method of producing drinking water according to the invention, of 20 m³/h. Such a value is arbitrarily chosen, it being clearly understood that a different water flow rate could be used, for example in a range of 80 to 200 m³/h, in which case the other rates mentioned in the text which follows will be adjusted accordingly.

The chamber through which the water circulates during step b) of the method in accordance with the invention conventionally contains between 150 and 500 kg of calcium carbonate in solid form per m³/h of treated water.

The water obtained at the end of step b) thus advantageously comprises between 80 and 170 mg/l, preferably 130 mg/l, of calcium ions in bicarbonate form.

The solution used during step c) comprises, for example, between 80 and 400 g/l, preferably 90 g/l, of calcium sulfate and/or between 100 and 300 g/l, preferably 240 g/l, of calcium chloride.

For 20 m³/h of water treated during the method according to the invention, said calcium sulfate and/or calcium chloride solution is advantageously added to the water obtained in step b) at a rate of between 15 and 60 l/h, for example of 30 l/h.

At the end of step c), the water advantageously comprises between 20 and 100 mg/l, preferably 40 mg/l, of calcium ions in sulfate form, and/or between 20 and 140 mg/l, preferably 130 mg/l, of calcium ions in chloride form.

The method in accordance with the present invention has the advantage of making it possible to obtain water rich in calcium which comprises in particular a high level of calcium ions in bicarbonate form (Ca(HCO₃)₂). This form, which is ionized, has the advantage, compared with the sulfate and chloride forms, of making the calcium more available in the intestine and of not conferring an unpleasant taste on the water.

In addition, the simultaneous presence of calcium ions in bicarbonate, chloride and/or sulfate form, and the distribution of these various ionic forms, makes it possible to optimize the taste of the water.

The method described above makes it possible to obtain plain water. If it is desired to obtain aerated water, the method in accordance with the invention may comprise, after step c), a step of dissolving carbon dioxide in water, for example at a rate of between 60 and 120 kg/h (expressed for a treated water flow rate of 20 m³/h), so that the water obtained after dissolving the carbon dioxide comprises between 3 and 6 g/l of this gas, preferably about 4.5 g/l.

The subject of the invention is also drinking water, characterized in that it can be obtained according to the method as defined above. Such water advantageously comprises at least 300 mg/l of calcium ions.

The water according to the invention comprises between 80 and 170 mg/l, preferably 130 mg/l, of calcium ions in bicarbonate form, whose advantages on the taste of the water and on the assimilation of calcium have been mentioned above.

The water according to the invention may also comprise between 20 and 100 mg/l, preferably 40 mg/l, of calcium ions in sulfate form, and/or between 20 and 140 mg/l, preferably 130 mg/l, of calcium ions in chloride form.

Regular consumption of the water in accordance with the invention makes it possible to cover a significant part of the RDI of calcium, and to thereby reduce the risk of a calcium deficiency, of which the harmful consequences on health, such as the risk of osteoporosis and, for elderly persons, of bone fractures, are known.

The water in accordance with the invention may also comprise, in addition, up to 80 mg/l, preferably 50 mg/l, of magnesium ions (which corresponds to about 15% of the RDI, which is 350 mg) and/or taste modifying agents, such as fruit or mint flavors.

Preferably, the water according to the invention is plain water. As a variant, it may be aerated water.

The invention will be better understood with the aid of the description which follows, which refers to an example of production of water rich in calcium, and to the accompanying drawing, which schematically represents a plant for carrying out the method of production according to the invention.

It is clearly understood, however, that this example is given solely by way of illustration of the subject of the invention, and does not constitute in any manner a limitation thereto.

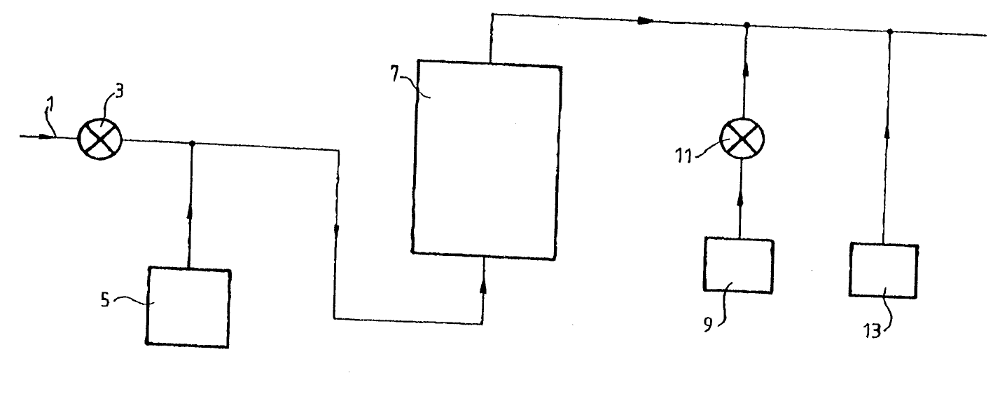

FIG. 1 represents a plant for carrying out the method for producing water rich in calcium in accordance with the invention.

Raw water, such as drinking water from the water supply comprising less than 50 mg/l of calcium ions, or less than 150 mg/l, as mentioned above, is introduced into the pipe 1 by means of a pump 3, at a flow rate of between 10 and 100 m³/h, for example equal to 20 m³/h.

Carbon dioxide, stored in the vessel 5, is dissolved in water at a rate of between 4 and 10 kg/h, preferably equal to 7 kg/h, so as to obtain water whose carbon dioxide concentration is between 200 and 500 mg/l, preferably of about 350 mg/l.

The water charged with carbon dioxide (“carbonated water”) thus obtained is then introduced into a vessel 7, for example 2.5 m in height and having a cylindrical diameter of 1.8 m, wherein is confined calcium carbonate in solid form. The rate of passage of the carbonated water into the vessel 7 is between 10 and 30 m³/h, for example equal to 20 m³/h.

The reaction between the water, acidified by the presence of carbon dioxide, and the solid calcium carbonate results in the formation of calcium bicarbonate, a salt which is solubilized in water. During its passage into the vessel 7, the water is therefore charged with bicarbonate and with calcium (in an amount of 120 to 150 mg/l of calcium) and becomes simultaneously depleted of carbon dioxide, whose concentration at the outlet of the vessel 7 is between 150 and 250 mg/l, in the present case about 220 mg/l.

For a flow rate of 20 m³/h of treated water, a solution comprising between 80 and 400 g/l, for example 90 g/l, of calcium sulfate and/or between 100 and 300 g/l, for example 240 l, of calcium chloride, stored in the vessel 9, is added to the water enriched with calcium carbonate, after leaving the vessel 7, via a pump 11, at an introduction rate of between 20 and 40 l/h, for example equal to 30 l/h.

Plain water is thus obtained which comprises, in addition to the calcium ions in bicarbonate form, between 20 and 100 mg/l, preferably 40 mg/l, of calcium ions in sulfate form and/or between 20 and 140 mg/l, preferably 130 mg/l, of calcium ions in chloride form.

If it is desired to obtain aerated water, carbon dioxide, stored in the container 13, is then injected into the water, at a rate of between 60 and 120 kg/h, preferably equal to 90 kg/h (expressed relative to a flow rate of treated water of 20 m³/h). Water is thus obtained which comprises between 3 and 6 g/l of carbon dioxide, preferably about 4.5 g/l.

As a variant, the production of aerated water could be carried out by injecting carbon dioxide into water in a sufficient quantity right at the beginning of the method. In accordance with this variant, from 1 to 2 g/l of carbon dioxide, obtained from the vessel 5, are injected into the raw water introduced into the pipe 1. This variant has the advantage of reducing the size of the vessel 7, which comprises calcium carbonate in solid form; during step b) of the method according to the invention, it will be possible to use 4 to 5 times less calcium carbonate compared to what was mentioned above.

The water obtained, plain or aerated, is finally conveyed to a storage tank before being bottled.

It is clearly understood that, in addition to the means schematically represented in FIG. 1, the device appropriate for carrying out the method in accordance with the invention comprises other means which will appear immediately necessary to persons skilled in the art, such as buffer tanks, valves at the inlet and outlet of each of the containers, means for controlling and regulating these valves, and the like.

1. A method for producing drinking water characterized in that it comprises the following steps:
a) dissolving carbon dioxide in weakly mineralized drinking water,
b) circulating the carbonated water derived from a) in a chamber (7) wherein is confined calcium carbonate in solid form, and
c) adding, to the water derived from step b), a solution comprising calcium sulfate and/or calcium chloride.

2. The method as claimed in claim 1, characterized in that said weakly mineralized water comprises less than 50 mg/l of calcium ions.

3. The method as claimed in claim 1 or claim 2, characterized in that the water comprises, at the end of step a), between 200 and 500 mg/l of carbon dioxide, preferably about 350 mg/l.

4. The method as claimed in any one of the preceding claims, characterized in that the vessel (7) contains between 150 and 500 kg of calcium carbonate in solid form per m³/h of treated water.

5. The method as claimed in any one of the preceding claims, characterized in that the water obtained at the end of step b) comprises between 80 and 170 mg/l, preferably 130 mg/l, of calcium ions in bicarbonate form.

6. The method as claimed in any one of the preceding claims, characterized in that said solution used during step c) comprises between 80 and 400 g/l, preferably 90 g/l, of calcium sulfate and/or between 100 and 300 g/l, preferably 240 g/l, of calcium chloride.

7. The method as claimed in claim 6, characterized in that said calcium sulfate and/or calcium chloride solution is added to the water obtained in step b) at a rate of between 15 and 60 l/h.

8. The method as claimed in any one of the preceding claims, characterized in that the water obtained at the end of step c) comprises between 20 and 100 mg/l, preferably 40 mg/l, of calcium ions in sulfate form, and/or between 20 and 140 mg/l, preferably 130 mg/l, of calcium ions in chloride form.

9. The method as claimed in any one of the preceding claims, characterized in that the water obtained at the end of step c) comprises at least 300 mg/l of calcium ions.

10. The method as claimed in any one of the preceding claims, characterized in that it comprises, after step c), a step of dissolving carbon dioxide in water.

11. The method as claimed in claim 10, characterized in that the carbon dioxide is dissolved in water at a rate of between 60 and 120 kg/h.

12. The method as claimed in claim 10 or claim 11, characterized in that the water obtained after dissolving the carbon dioxide comprises between 3 and 6 g/l of carbon dioxide, preferably about 4.5 g/l.

13. A drinking water, characterized in that it can be obtained according to the method as defined in any one of the preceding claims.

14. The water as claimed in claim 13, characterized in that it comprises at least 300 mg/l of calcium ions.

15. The water as claimed in claim 13 or claim 14, characterized in that it comprises between 80 and 170 mg/l, preferably 130 mg/l, of calcium ions in bicarbonate form.

16. The water as claimed in any one of claims 13 to 15, characterized in that it comprises between 20 and 100 mg/l, preferably 40 mg/l, of calcium ions in sulfate form.

17. The water as claimed in any one of claims 13 to 16, characterized in that it comprises between 20 and 140 mg/l, preferably 130 mg/l, of calcium ions in chloride form.

18. The water as claimed in any one of claims 13 to 17, characterized in that it comprises, in addition, up to 80 mg/l, preferably 50 mg/l, of magnesium ions.

19. The water as claimed in any of claims 13 to 18, characterized in that it comprises, in addition, taste modifying agents.

20. The water as claimed in any one of claims 13 to 19, characterized in that it is plain water.

21. The water as claimed in any one of claims 13 to 19, characterized in that it is aerated water.
